(19) United States
(12) Patent Application Publication
(10) Pub. No.: US 2015/0037621 A1
(43) Pub. Date: Feb. 5, 2015

(54) ENERGY STORAGE DEVICE

(71) Applicant: EMPIRE TECHNOLOGY DEVELOPMENT LLC, Wilmington, DE (US)

(72) Inventor: Hui Huang Chang, Singapore (SG)

(21) Appl. No.: 14/353,494

(22) PCT Filed: Jul. 24, 2013
(86) PCT No.: PCT/US13/51755

§ 371 Date: Apr. 23, 2014

(51) Int. Cl. H01M 10/42; H01G 11/54; H01G 11/46; H01G 11/10; H01M 4/133; H01M 10/0525; H01M 10/0566; H01M 4/131; H01M 4/505; H01M 4/587; H01G 11/26; H01M 10/04

(52) U.S. Cl. CPC H01M 10/4264; H01G 11/26; H01G 11/54; H01G 11/46; H01G 11/10; H01M 10/0431; H01M 10/0525; H01M 10/0566; H01M 4/131; H01M 4/505; H01M 4/587; H01M 4/133; H01M 2300/0025; H01M 2004/028
USPC 429/7; 361/502; 29/25.03

(57) ABSTRACT

Embodiments of the disclosure set forth energy storage devices. Some example energy storage devices include a first hybrid capacitor, a first battery and an electric double-layer capacitor. The first hybrid capacitor includes a first positive electrode, a first negative electrode and a first electrolyte. The first battery couples to the first hybrid capacitor and includes a second positive electrode, a second negative electrode and a second electrolyte. The electric double-layer capacitor couples to the first battery and includes a third positive electrode, a third negative electrode and a third electrolyte. The first positive electrode includes the second positive electrode.

### BACKGROUND OF THE DISCLOSURE

While personal electronic devices (e.g., intelligent cellular phones and tablet computers and the like) become more popular in daily lives, providing a long and stable power for the personal electronic devices becomes an issue. Conventional power solutions for such and other types of electronic devices have adoption, technical, and/or other issues.

### SUMMARY

Embodiment of the disclosure set forth energy storage devices. Some example energy storage devices include a first hybrid capacitor, a first battery and an electric double-layer capacitor. The first hybrid capacitor includes a first positive electrode, a first negative electrode and a first electrolyte. The first battery, coupled to the first hybrid capacitor, includes a second positive electrode, a second negative electrode and a second electrolyte. The electric double-layer capacitor, coupled to the first battery, includes a third positive electrode, a third negative electrode and a third electrolyte. The first positive electrode includes the second positive electrode.

Embodiments of the disclosure set forth methods for making an energy storage device. Some example methods include aligning a plurality of electrodes so that a first electrode, a second electrode, a third electrode and a fourth electrode are aligned substantially in parallel with each other and forming a first hybrid capacitor, a first battery, a second hybrid capacitor, and an electric double-layer capacitor in the energy storage device. The first hybrid capacitor includes the first electrode as a positive electrode of the first hybrid capacitor and the second electrode as a negative electrode of the first hybrid capacitor. The first battery includes the third electrode as a positive electrode of the first battery and the second electrode as a negative electrode of the first battery. The second hybrid capacitor includes the third electrode as a positive electrode of the second hybrid capacitor and the fourth electrode as a negative electrode as the negative electrode of the second hybrid capacitor. The electric double-layer capacitor includes the first electrode as a positive electrode of the electric double-layer capacitor and the fourth electrode as a negative electrode of the electric double-layer capacitor.

Embodiments of the disclosure set forth methods for making an energy storage device. Some example methods include aligning a plurality of electrodes so that a first electrode, a second electrode, a third electrode and a fourth electrode are aligned substantially in parallel with each other and forming a first battery, a first hybrid capacitor, a second battery, and an electric double-layer capacitor in the energy storage device. The first battery includes the first electrode as a positive electrode of the first hybrid capacitor and the second electrode as a negative electrode of the first hybrid capacitor. The first hybrid capacitor includes the third electrode as a positive electrode of the first battery and the second electrode as a negative electrode of the first battery. The second battery includes the third electrode as a positive electrode of the second hybrid capacitor and the fourth electrode as a negative electrode as the negative electrode of the second hybrid capacitor. The electric double-layer capacitor includes the first electrode as a positive electrode of the electric double-layer capacitor and the fourth electrode as a negative electrode of the electric double-layer capacitor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A is a perspective view showing an example stacking structure of an energy storage device;

FIG. 1B is a side view showing the example stacking structure illustrated in FIG. 1A;

FIG. 2 is a perspective view showing an example rolled structure of an energy storage device;

FIG. 3 is a flowchart of a manufacturing method for making an example energy storage device;

FIG. 4 is a flowchart of another manufacturing method for making an example energy storage device; and

FIG. 5 is a block diagram of an example computing device configured to receive power from an energy storage device, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to manufacturing methods, apparatus, and devices related to an energy storage device.

In some embodiments of this disclosure, an energy storage device includes a first hybrid capacitor, a first battery and an electric double-layer capacitor (EDLC). The first hybrid capacitor may include a first positive electrode, a first negative electrode and a first electrolyte. The first battery may be coupled to the first hybrid capacitor. The first battery may include a second positive electrode, a second negative electrode and a second electrolyte. The electric double-layer capacitor may be coupled to the first battery. The electric double-layer capacitor may include a third positive electrode, a third negative electrode and a third electrolyte. The first positive electrode may include the second positive electrode. The energy storage device may be configured so that the first positive electrode is the second positive electrode. The first negative electrode of the first hybrid capacitor may be the second negative electrode of the battery and/or the third negative electrode of the electric double-layer capacitor. The electrodes may be separated from each other by one or more insulating materials. The first electrolyte, the second electrolyte and the third electrolyte may be the same or different.

In some embodiments, the first negative electrode of the first hybrid capacitor may be the third negative electrode of the electric double-layer capacitor. The first positive electrode of the first hybrid capacitor may be the third positive electrode of the electric double-layer capacitor.

In some embodiments, the first positive electrode of the first hybrid capacitor may be electrically coupled to the third positive electrode of the electric double-layer capacitor to form a positive electrode of the energy storage device. The first negative electrode of the first hybrid capacitor may be electrically coupled to the second negative electrode of the first battery to form a negative electrode of the energy storage device.

In some embodiments, the energy storage device may further include a second hybrid capacitor. The second hybrid capacitor may include a fourth positive electrode, a fourth negative electrode and a fourth electrolyte. The second negative electrode of the first battery may be the fourth negative electrode of the second hybrid capacitor. The third positive electrode of the electric double-layer capacitor may be the fourth positive electrode of the second hybrid capacitor. The fourth electrolyte may be the same as or different from the first electrolyte, the second electrolyte or the third electrolyte. The first positive electrode of the first hybrid capacitor may be electrically coupled to the fourth positive electrode to form a positive electrode of the energy storage device.

Some example material for the first positive electrode may include, without limitation, Ni(OH)2, MnO₂, NiO, λ-Mn0₂, (PbO₂)PbSO₄ and PbO₂/Sn0₂/Ti and/or other(s). Some example material for the first negative electrode may include, without limitation, carbon, carbon nanotube, activated carbon and/or other(s). Some example material for the second positive electrode may include, without limitation, Ni(OH)2, MnO₂, NiO, λ-MnO₂, (PbO₂)PbSO₄ and PbO₂/SnO₂/Ti and/or other(s). Some example material for the second negative electrode may include, without limitation, (Zn(OH)₂)Zn, (Fe(OH)₂)Fe, LiMn₂O₄, Li₄Ti₅O₁₂, Li-TiS₂, Li-MoS₂, Li-MnO₂, LiCoO₂, Li-C-CoO₂ and/or other(s). Some example material for the third positive electrode may include, without limitation, carbon and activated carbon and/or other(s). Some example material for the third negative electrode may include, without limitation, carbon, carbon nanotube, activated carbon and/or other(s). Some example material for the fourth positive electrode may include, without limitation, carbon and activated carbon and/or other(s). Some example material for the fourth negative electrode may include, without limitation, Ni(OH)2, MnO₂, NiO, λ-MnO₂, (PbO₂)PbSO₄ and PbO₂/SnO₂/Ti and/or other(s).

The first electrolyte, the second electrolyte, the third electrolyte and the fourth electrolyte may be aqueous or non-aqueous. Some example electrolytes may include, without limitation, KOH, K₂SO₄, H₂SO₄, OH-KOH, Li₂SO₄, LiPF₆ECDMC, lithium salt with a non-aqueous solvent and/or other(s).

Methods of making the energy storage device are also described herein. The methods may include aligning a plurality of electrodes so that a first electrode, a second electrode, a third electrode and a fourth electrode are substantially parallel. A first hybrid capacitor included in the energy storage device may comprise the first electrode as the positive electrode of the first hybrid capacitor and the second electrode as the negative electrode of the first hybrid capacitor. A battery included in the energy storage device may comprise the third electrode as the positive electrode of the battery and the second electrode as the negative electrode of the battery. A second hybrid capacitor included in the energy storage device may comprise the third electrode as the positive electrode of the second hybrid capacitor and the fourth electrode as the negative electrode of the second hybrid capacitor. An electric double-layer capacitor included in the energy storage device may comprise the first electrode as the positive electrode of the electric double-layer capacitor and the fourth electrode as the negative electrode of the electric double-layer capacitor.

In some embodiments, a first insulator may be disposed between the first positive electrode and the first negative electrode. A second insulator may be disposed between the first negative electrode and the second positive electrode. A third insulator may be disposed between the second positive electrode and the second negative electrode. A fourth insulator may be disposed between the first positive electrode and the second negative electrode.

In some embodiments, an electrolyte may be introduced among the electrodes and the insulators. The electrolyte may be aqueous or non- aqueous.

In some other embodiments, methods of making the energy storage device are also described herein. The methods may include aligning a plurality of electrodes so that a first electrode, a second electrode, a third electrode and a fourth electrode are substantially parallel. A first battery included in the energy storage device may comprise the first electrode as the positive electrode of the first battery and the second electrode as the negative electrode of the first battery. A hybrid capacitor included in the energy storage device may comprise the third electrode as the positive electrode of the hybrid capacitor and the second electrode as the negative electrode of the hybrid capacitor. A second battery included in the energy storage device may comprise the third electrode as the positive electrode of the second battery and the fourth electrode as the negative electrode of the second battery. An electric double-layer capacitor included in the energy storage device may comprise the first electrode as the positive electrode of the electric double-layer capacitor and the fourth electrode as the negative electrode of the electric double-layer capacitor.

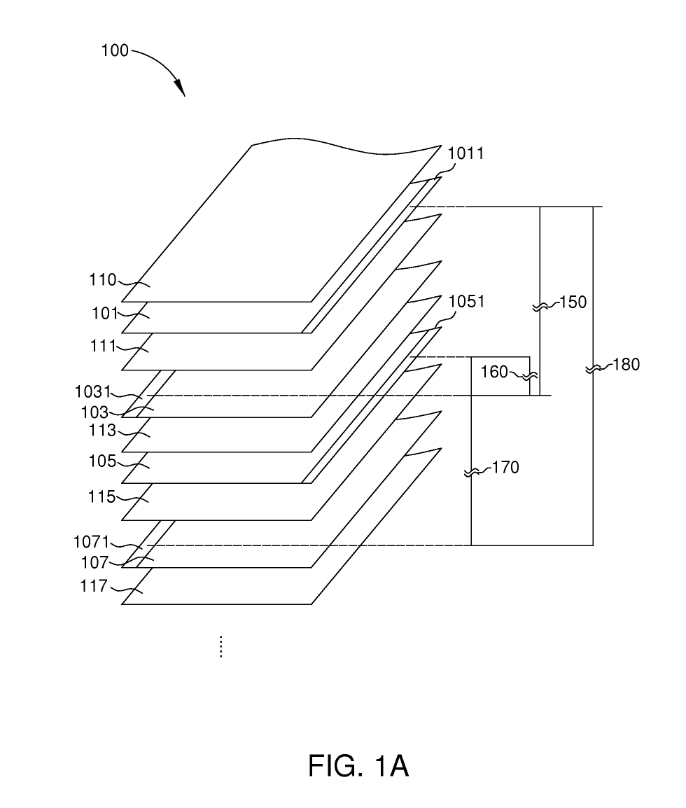

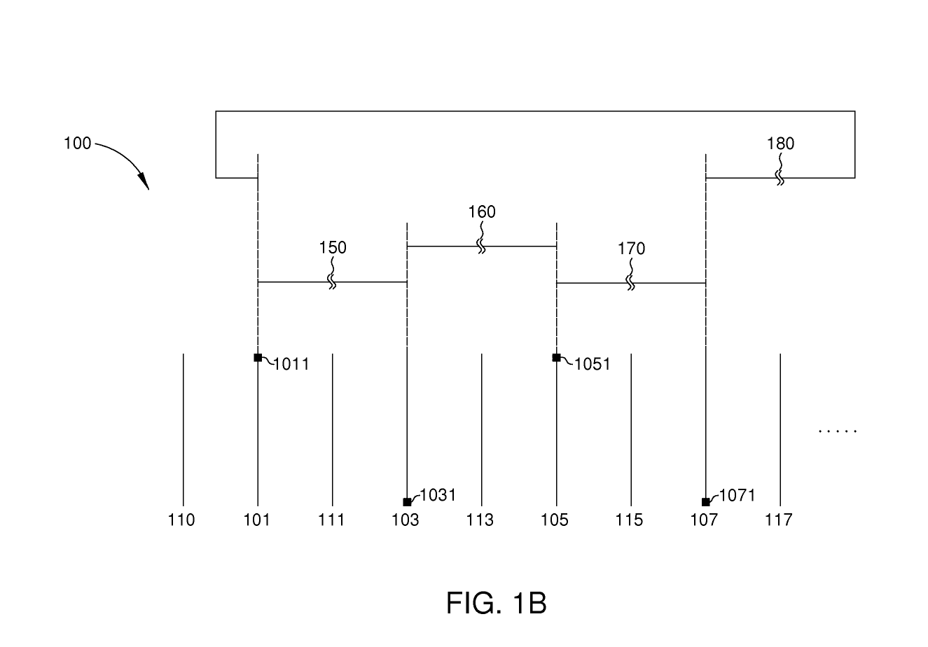

FIG. 1A is a perspective view showing an example stacking structure of an energy storage device 100 in accordance with embodiments of the disclosure. The energy storage device 100 may include a stacking structure having multiple stacks. The stacks may include positive electrodes 101 and 105, negative electrodes 103 and 107 and insulator materials 110, 111, 113, 115 and 117. The stacks may be arranged so that positive electrode stacks and negative electrode stacks are interchangeably or alternately arranged. An insulator material stack may be arranged between any two adjacent electrode stacks to prevent short circuits between the electrode stacks. An electrolyte may be introduced between any two adjacent stacks.

FIG. 1B is a side view showing the example stack structure of the energy storage device 100 illustrated in FIG. 1A in accordance with embodiments of the disclosure. The positive electrodes 101 and 105 may be coupled through conductive materials 1011 and 1051 to form a positive electrode of the energy storage device 100. The negative electrodes 103 and 107 may be coupled through conductive materials 1031 and 1071 to form a negative electrode of the energy storage device 100. The conductive materials 1011 and 1051 for the positive electrodes 101 and 105 may be disposed at a first side of the energy storage device 100. On the other hand, the conductive materials 1031 and 1071 for the negative electrodes 103 and 107 may be disposed at a second side opposite to the first side of the energy storage device 100 to prevent short circuits.

In conjunction with FIGS. 1A and 1B, the energy storage device 100 may include a first hybrid capacitor 150, a second hybrid capacitor 170, a battery 160 and an electric double-layer capacitor 180. The first hybrid capacitor 150 may have the positive electrode 101 and the negative electrode 103. The battery 160 may have the positive electrode 105 and the negative electrode 103. The second hybrid capacitor 170 may have the positive electrode 105 and the negative electrode 107.

The electric double-layer capacitor 180 may have the positive electrode 101 and the negative electrode 107.

It is noted that the energy storage device 100 may include additional positive electrode stacks, negative electrode stacks and insulator material stacks than what is depicted in FIGS. 1A and 1B. The additional stacks may be arranged so that positive electrode stacks and negative electrode stacks are interchangeably or alternately arranged, and an insulator material stack may be arranged between any two adjacent electrode stacks.

Alternatively or additionally, the energy storage device 100 may include a first battery, a second battery, a hybrid capacitor and an electric double-layer capacitor. The first battery may have the positive electrode 101 and the negative electrode 103. The hybrid capacitor may have the positive electrode 105 and the negative electrode 103. The second battery may have the positive electrode 105 and the negative electrode 107. The electric double-layer capacitor may have the positive electrode 101 and the negative electrode 107. The positive electrodes 101 and 105 may be coupled through conductive materials 1011 and 1051 to form a positive electrode of the energy storage device 100. The negative electrodes 103 and 107 may be coupled through conductive materials 1031 and 1071 to form a negative electrode of the energy storage device 100.

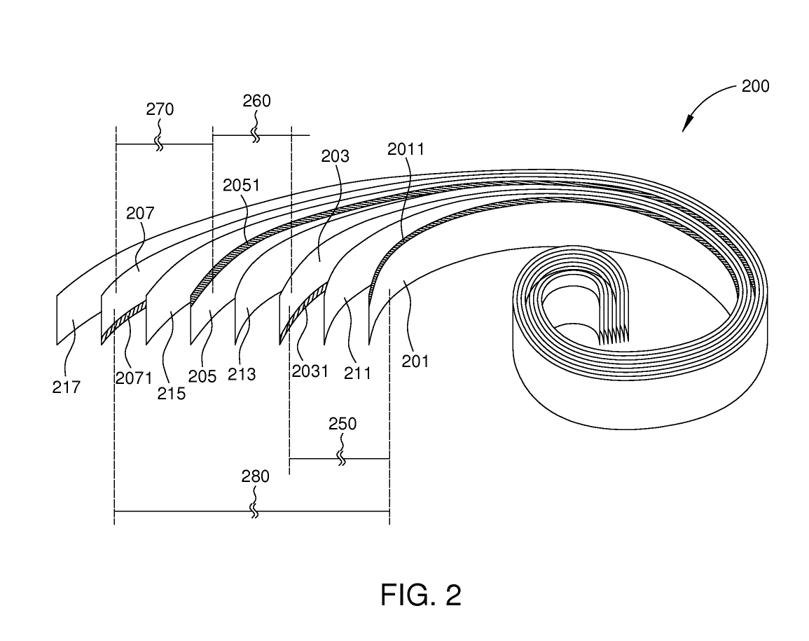

Alternatively, the stacking structure of an energy storage device set forth above may be rolled to form a rolled structure. FIG. 2 is a perspective view showing an example rolled structure of an energy storage device 200. The energy storage device 200 may include a first hybrid capacitor 250, a second hybrid capacitor 270, a battery 260, an electric double-layer capacitor 280, and insulator materials 210, 211, 213, 215 and 217. The first hybrid capacitor 250 may have the positive electrode 201 and the negative electrode 203. The battery 260 may have the positive electrode 205 and the negative electrode 203. The second hybrid capacitor 270 may have the positive electrode 205 and the negative electrode 207. The electric double-layer capacitor 280 may have the positive electrode 201 and the negative electrode 207.

It is noted that the energy storage device 200 may include additional positive electrode stacks, negative electrode stacks and insulator material stacks than what is depicted in FIG. 2. The additional stacks may be arranged so that positive electrode stacks and negative electrode stacks are interchangeably or alternately arranged, and an insulator material stack may be arranged between any two adjacent electrode stacks.

Alternatively or additionally, the energy storage device 200 may include a first battery, a second battery, a hybrid capacitor and an electric double-layer capacitor. The first battery may have the positive electrode 201 and the negative electrode 203. The hybrid capacitor may have the positive electrode 205 and the negative electrode 203. The second battery may have the positive electrode 205 and the negative electrode 207. The electric double-layer capacitor may have the positive electrode 201 and the negative electrode 207. The positive electrodes 201 and 205 may be coupled through conductive materials 2011 and 2051 to form a positive electrode of the energy storage device 200. The negative electrodes 203 and 207 may be coupled through conductive materials 2031 and 2071 to form a negative electrode of the energy storage device 200.

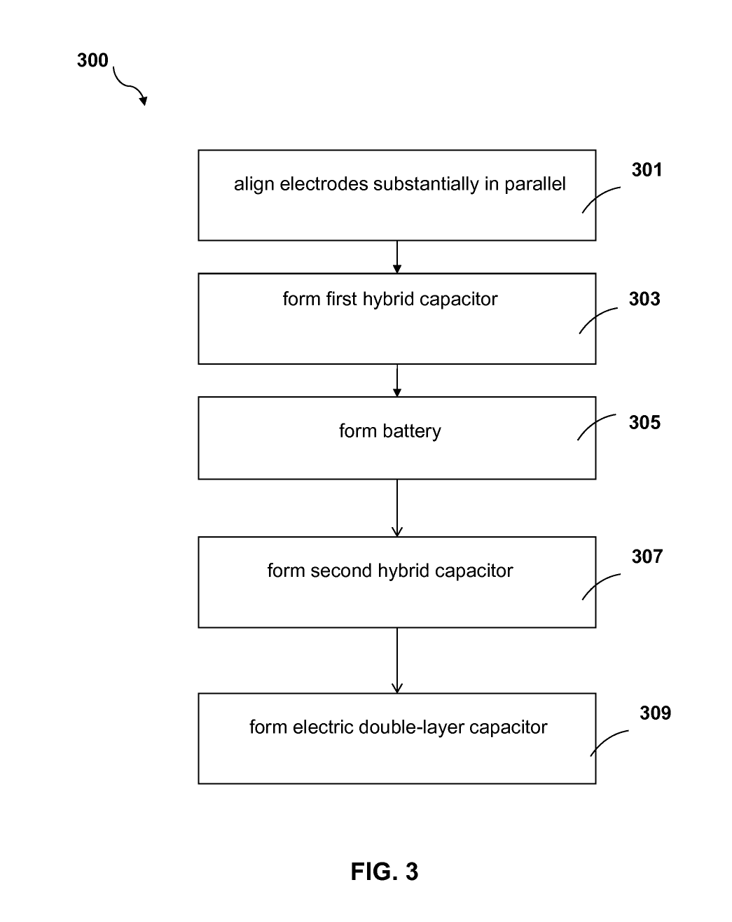

FIG. 3 is a flowchart of a manufacturing method for making an example energy storage device in accordance with embodiments of the disclosure. Method 300 may include one or more operations, functions, or actions as illustrated by one or more of blocks 301, 303, 305, 307, and/or 309. Although the blocks are illustrated in a sequential order, these blocks may also be performed in parallel, and/or in a different order than those described herein. Also, the various blocks may be combined into fewer blocks, divided into additional blocks, and/or eliminated based upon the particular implementation. Additional blocks may be provided that represent other operations, functions, or actions. Although method 300 is described in conjunction with energy storage device 100 of FIGS. 1 A and 1B and energy storage device 200 of FIG. 2, any suitable energy storage device can use and benefit from the performance of method 300.

Method 300 may begin in block 301 “align electrodes substantially in parallel.” Block 301 may be followed by block 303 “form first hybrid capacitor,” block 303 may be followed by block 305 “form battery,” block 305 may be followed by block 307 “form second hybrid capacitor,” and block 307 may be followed by block 309 “form electric double-layer capacitor.”

In block 301, a first electrode, a second electrode, a third electrode, and a fourth electrode may be aligned substantially in parallel with each other. Any of the electrodes may comprise an electrode contact. The first electrode contact and the third electrode contact may be aligned at one edge of the energy storage device 100. The second electrode contact and the fourth electrode contact may be aligned at the other edge of the energy storage device 100. The first electrode contact of the first electrode may be coupled with the third electrode contact of the third electrode via soldering or other technical feasible approaches. The second electrode contact of the second electrode may be coupled with the fourth electrode contact of the fourth electrode via soldering or other technical feasible approaches. Accordingly, the positive electrode contacts may be connected at one edge of the energy storage device 100 and the negative electrode contacts may be connected at the other edge of the energy storage device 100. The energy storage device 100 may have a smaller contact resistance than a line transmission design.

Some example materials for the first electrode may include, without limitation, carbon and activated carbon and/or other(s). Some example materials for the second electrode may include, without limitation, (Zn(OH)₂)Zn, (Fe(OH)₂)Fe, LiMn₂O₄, Li₄Ti₅O₁₂, Li-TiS₂, Li-MoS₂, Li-MnO₂, LiCoO₂, Li-C-CoO₂ and/or other(s). Some example materials for the third electrode may include, without limitation, Ni(OH)2, MnO₂, NiO, A-MnO₂, (PbO₂)PbSO₄ and Pb0₂/SnO₂/Ti and/or other(s). Some example materials for the fourth electrode may include, without limitation, carbon, carbon nanotube, activated carbon and/or other(s).

In block 303, a first hybrid capacitor may be formed. The first hybrid capacitor may be formed in the energy storage device 100 and may comprise the first electrode as the positive electrode of the first hybrid capacitor and the second electrode as the negative electrode of the first hybrid capacitor.

In block 305, a battery may be formed. The battery may be formed in the energy storage device 100 and may comprise the third electrode as the positive electrode of the battery and the second electrode as the negative electrode of the battery.

In block 307, a second hybrid capacitor may be formed. The second hybrid capacitor may be formed in the energy storage device 100 and may comprise the third electrode as the positive electrode of the second hybrid capacitor and the fourth electrode as the negative electrode of the second hybrid capacitor.

In block 309, an electric double-layer capacitor may be formed in the energy storage device 100 and may comprise the first electrode as the positive electrode of the electric double-layer capacitor and the fourth electrode as the negative electrode of the electric double-layer capacitor.

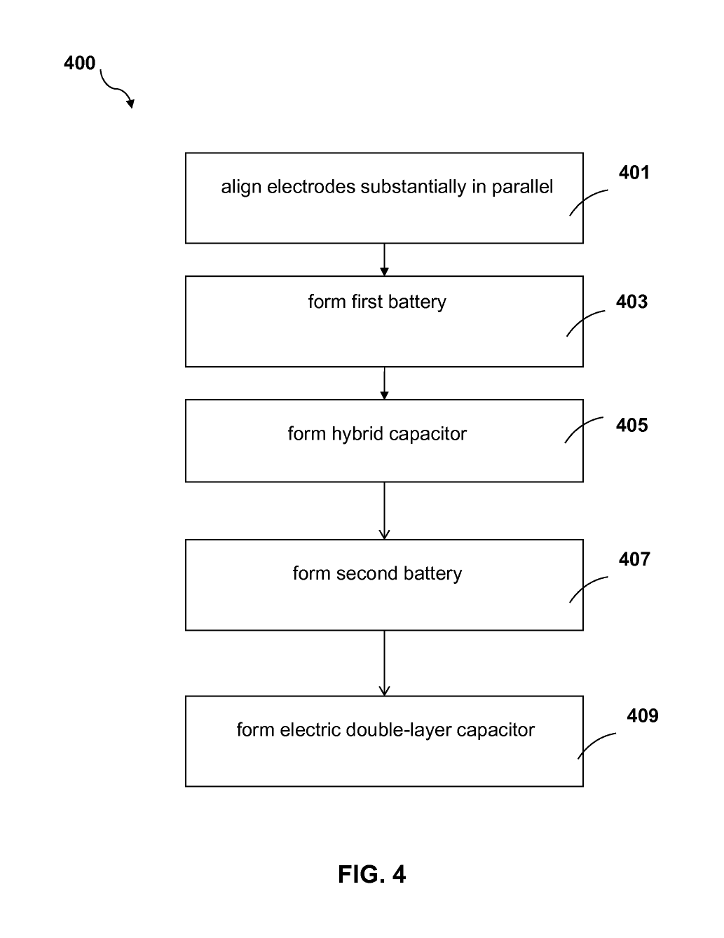

In some other embodiments, a method for making an energy storage device may include the operations shown in FIG. 4. FIG. 4 is a flowchart of a manufacturing method for making an example energy storage device in accordance with embodiments of the disclosure. Method 400 may include one or more operations, functions, or actions as illustrated by one or more of blocks 401, 403, 405, 407, and/or 409. Although the blocks are illustrated in a sequential order, these blocks may also be performed in parallel, and/or in a different order than those described herein. Also, the various blocks may be combined into fewer blocks, divided into additional blocks, and/or eliminated based upon the particular implementation. Additional blocks may be provided that represent other operations, functions, or actions. Although method 400 is described in conjunction with energy storage device 100 of FIGS. 1A and 1B and energy storage device 200 of FIG. 2, any suitable energy storage device can use and benefit from the performance of method 300.

Method 400 may begin in block 401 “align electrodes substantially in parallel.” Block 401 may be followed by block 403 “form first battery,” block 403 may be followed by block 405 “form hybrid capacitor,” block 405 may be followed by block 407 “form second battery,” and block 407 may be followed by block 409 “form electric double-layer capacitor.”

In block 401, a first electrode, a second electrode, a third electrode, and a fourth electrode may be aligned substantially in parallel with each other. Any of the electrodes may comprise an electrode contact. The first electrode contact and the third electrode contact may be aligned at one edge of the energy storage device 100. The second electrode contact and the fourth electrode contact may be aligned at the other edge of the energy storage device 100. The first electrode contact of the first electrode may be coupled with the third electrode contact of the third electrode via soldering or other technical feasible approaches. The second electrode contact of the second electrode may be coupled with the fourth electrode contact of the fourth electrode via soldering or other technical feasible approaches. Accordingly, the positive electrode contacts may be connected at one edge of the energy storage device 100 and the negative electrode contacts may be connected at the other edge of the energy storage device 100. The energy storage device 100 may have a smaller contact resistance than a line transmission design.

Some example materials for the first electrode may include, without limitation, carbon and activated carbon and/or other(s). Some example materials for the second electrode may include, without limitation, (Zn(OH)₂)Zn, (Fe(OH)₂)Fe, LiMn₂O₄, Li₄Ti₅O₁₂, Li-TiS₂, Li-MoS₂, Li-MnO₂, LiCoO₂, Li-C-CoO₂ and/or other(s). Some example materials for the third electrode may include, without limitation, Ni(OH)2, Mn0₂, NiO, A-Mn0₂, (Pb0₂)PbSO₄ and Pb0₂/Sn0₂/Ti and/or other(s). Some example materials for the fourth electrode may include, without limitation, carbon, carbon nanotube, activated carbon and/or other(s).

In block 403, a first battery may be formed. The first battery may be formed in the energy storage device 100 and may comprise the first electrode as the positive electrode of the first battery and the second electrode as the negative electrode of the first battery.

In block 405, a hybrid capacitor may be formed. The hybrid capacitor may be formed in the energy storage device 100 and may comprise the third electrode as the positive electrode of the battery and the second electrode as the negative electrode of the battery.

In block 407, a second battery may be formed. The second battery may be formed in the energy storage device 100 and may comprise the third electrode as the positive electrode of the second battery and the fourth electrode as the negative electrode of the second battery.

In block 409, an electric double-layer capacitor may be formed in the energy storage device 100 and may comprise the first electrode as the positive electrode of the electric double-layer capacitor and the fourth electrode as the negative electrode of the electric double-layer capacitor.

### EXAMPLE

An energy storage device may include a first hybrid capacitor, a battery, an electric double-layer capacitor and a second hybrid capacitor and an electrolyte. The positive electrode of the first hybrid capacitor may be LiMn₂O₄, and the negative electrode of the first hybrid capacitor may be activated carbon. The positive electrode of the battery may be LiMn₂O₄, and the negative electrode of the battery may be LiC₆ (graphite). The positive and negative electrodes of the electric double-layer capacitor may be both activated carbon. The positive electrode of the second hybrid capacitor may be activated carbon, and the negative electrode of the second hybrid capacitor may be LiC₆ (graphite). The electrolyte may be 1M LiPF₆ in a mixture of ethylene carbonate and dimethyl carbonate. The volume ratio of ethylene carbonate and dimethyl carbonate in the mixture may be about 1 to 1.

The battery may provide a total energy density of approximately 400 Wh/Kg, for example. The two hybrid capacitors may provide a total energy density of approximately 40 Wh/Kg for example. The electric double-layer capacitor may have an energy density of approximately 36.7 Wh/Kg and an approximate power density of 83.6 kW/Kg, for example.

In some embodiments, the battery weighs around 40% of the energy storage device, the two hybrid capacitors weigh around 35% of the energy storage device and the electric double-layer capacitor weigh around 25% of the energy storage device. The energy density of the energy storage device may be about 183 Wh/Kg (i.e., 0.4×400 Wh/Kg+0.35×40 Wh/Kg+0.25×36.7 Wh/Kg).

The power density of some embodiments of the energy storage device may be dominated by the electric double-layer capacitor because the power density of the electric double-layer capacitor may be much greater than the power density of the hybrid capacitors or the power density of the battery. Therefore, the power density of the energy storage device may be about 20 KW/Kg (i.e., 0.25×83.6 kW/Kg), for example.

For the processes and methods disclosed herein, the functions performed in the processes and methods may be implemented in differing order. Furthermore, the described operations are only provided as examples, and some of the operations may be optional, combined into fewer operations, or expanded into additional operations.

In some embodiments, the electrodes of the energy storage device disclosed herein are connected back-to-back. The back-to-back configuration may effectively reduce the volume of the energy storage device. In addition, the energy storage device integrates at least one hybrid capacitor, at least one battery and at least one electric double-layer capacitor together. Therefore, the energy storage device can have the characteristics the hybrid capacitor, the battery and the electric double-layer capacitor. For example, the battery provides the needs of high energy density, the hybrid capacitor servers the needs of medium power density with medium energy density and the electric double-layer capacitor provides the needs of high power density in a short period which depends on the capacitance of the electric double-layer capacitor.

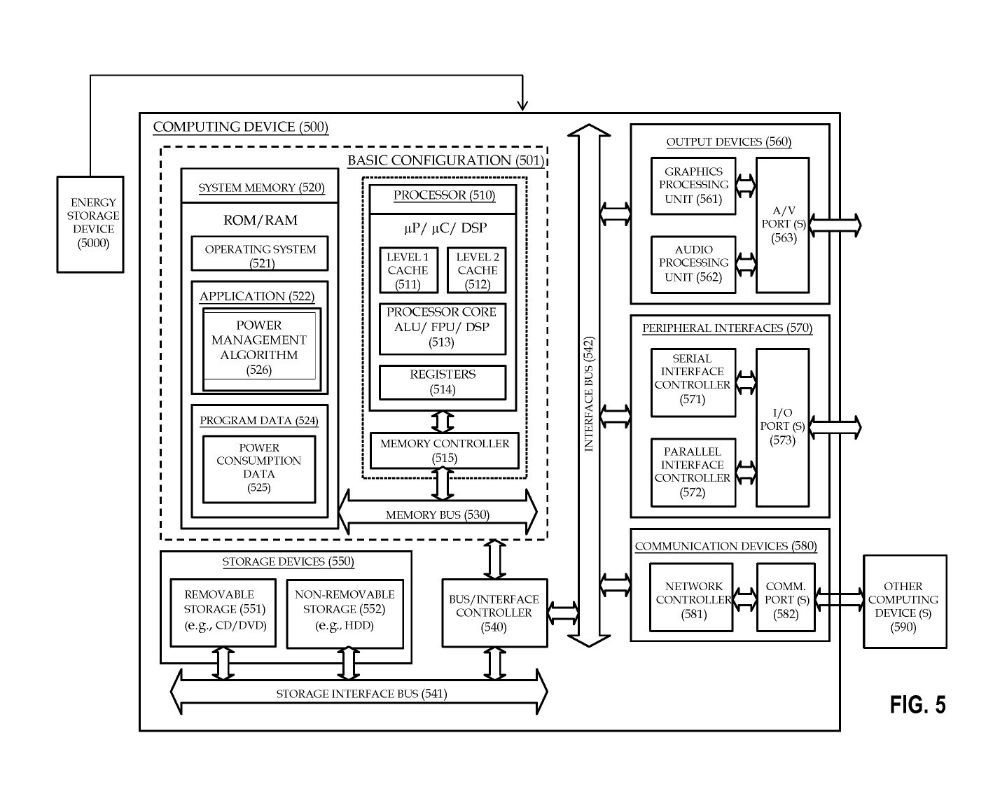

FIG. 5 is a block diagram of an example computing device configured to receive power from the energy storage device disclosed herein, arranged in accordance with at least some embodiments of the present disclosure. In a very basic configuration, computing device 500 typically includes one or more host processors 510 and a system memory 520. A memory bus 530 may be used for communicating between host processor 510 and system memory 520.

Depending on the desired configuration, host processor 510 may be of any type including but not limited to a microprocessor (μP), a microcontroller (μC), a digital signal processor (DSP), or any combination thereof. Processor 510 may include one more levels of caching, such as a level one cache 511 and a level two cache 512, a processor core 513, and registers 514. An example processor core 513 may include an arithmetic logic unit (ALU), a floating point unit (FPU), a digital signal processing core (DSP Core), or any combination thereof. An example memory controller 515 may also be used with processor 510, or in some implementations memory controller 515 may be an internal part of processor 510.

Depending on the desired configuration, system memory 520 may be of any type including but not limited to volatile memory (such as RAM), non-volatile memory (such as ROM, flash memory, etc.) or any combination thereof. System memory 520 may include an operating system 521, one or more applications 522, and program data 524. Application 522 may include a power management algorithm 526 that can be arranged to manage the power consumption of computing device 500. Program data 524 may include power consumption data 525. In some embodiments, application 522 may be arranged to operate with program data 524 on operating system 521 such that implementations of requesting power from energy storage device 5000 may be performed. Energy storage device 5000 may have the structure and other features described above with respect to FIGS. 1A, 1B, 2-4. This described basic configuration 501 is illustrated in FIG. 5 by those components within the inner dashed line.

Computing device 500 may have additional features or functionality, and additional interfaces to facilitate communications between basic configuration 501 and any required devices and interfaces. For example, a bus/interface controller 540 may be used to facilitate communications between basic configuration 501 and one or more data storage devices 550 via a storage interface bus 541. Data storage devices 550 may be removable storage devices 551, non-removable storage devices 552, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 520, removable storage devices 551 and non-removable storage devices 552 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 542 for facilitating communication from various interface devices (e.g., output devices 560, peripheral interfaces 570, and communication devices 580) to basic configuration 501 via bus/interface controller 540. Example output devices 560 include a graphics processing unit 561 and an audio processing unit 562, which may be configured to communicate to various external devices such as a display or speakers via one or more A/V ports 563. Example peripheral interfaces 570 include a serial interface controller or a parallel interface controller, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication device 580 includes a network controller, which may be arranged to facilitate communications with one or more other computing devices 590 over a network communication link via one or more communication ports.

The network communication link may be one example of a communication media. Communication media may typically be embodied by computer readable instructions, data structures, program modules, or other data in a modulated data signal, such as a carrier wave or other transport mechanism, and may include any information delivery media. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An energy storage device, comprising:
a first hybrid capacitor that includes a first positive electrode, a first negative electrode and a first electrolyte;
a first battery, coupled to the first hybrid capacitor, that includes a second positive electrode, a second negative electrode and a second electrolyte; and
an electric double-layer capacitor, coupled to the first battery, that includes a third positive electrode, a third negative electrode and a third electrolyte, wherein the first positive electrode includes the second positive electrode.

2. The energy storage device of claim 1, wherein the first negative electrode includes the third negative electrode.

3. The energy storage device of claim 1, wherein the first electrolyte, the second electrolyte and the third electrolyte are made of a same electrolyte material.

4. The energy storage device of claim 1, wherein the first negative electrode is electrically coupled to the second negative electrode to form a negative electrode of the energy storage device.

5. The energy storage device of claim 4, further comprising a second hybrid capacitor, which is coupled to any one or more of the first hybrid capacitor, the first battery, and the electric double-layer capacitor, that includes a fourth positive electrode, a fourth negative electrode and a fourth electrolyte, and wherein the second negative electrode includes the fourth negative electrode.

6. The energy storage device of claim 5, wherein the third positive electrode includes the fourth positive electrode.

7. The energy storage device of claim 5, wherein the fourth electrolyte includes the first electrolyte.

8. The energy storage device of claim 5, wherein the first positive electrode is electrically coupled to the fourth positive electrode to form a positive electrode of the energy storage device.

9. The energy storage device of claim 1, wherein the second negative electrode includes the third negative electrode.

10. The energy storage device of claim 9, further comprising a second battery, which is coupled to any one or more of the first hybrid capacitor, the first battery, and the electric double-layer capacitor, that includes a fourth positive electrode, a fourth negative electrode and a fourth electrolyte, and wherein the first negative electrode includes the fourth negative electrode.

11. The energy storage device of claim 10, wherein the fourth positive electrode includes the third positive electrode.

12. The energy storage device of claim 1, wherein the first positive electrode includes a LiMn₂O₄ material.

13. The energy storage device of claim 1, wherein the first negative electrode includes activated carbon.

14. The energy storage device of claim 1, wherein the second negative electrode includes graphite.

15. The energy storage device of claim 1, wherein the third positive electrode includes activated carbon.

16. The energy storage device of claim 1, wherein the first electrolyte includes a material of at least one of: LiPF₆, ethylene carbonate, and dimethyl carbonate.

17. (canceled)

18. A rolled structure comprising the energy storage device of claim 8, wherein the positive electrode of the energy storage device is disposed on the first surface of the rolled structure and the negative electrode of the energy storage device is disposed on the second surface of the rolled structure.

19. The rolled structure of claim 18, wherein the first surface and the second surface are on opposite sides of the rolled structure.

20. A method to make an energy storage device, comprising:
aligning a plurality of electrodes so that a first electrode, a second electrode, a third electrode and a fourth electrode are aligned substantially in parallel with each other,
forming a first hybrid capacitor in the energy storage device and that comprises the first electrode as a positive electrode of the first hybrid capacitor and the second electrode as a negative electrode of the first hybrid capacitor;
forming a battery in the energy storage device and that comprises the third electrode as a positive electrode of the battery and the second electrode as a negative electrode of the battery;
forming a second hybrid capacitor in the energy storage device and that comprises the third electrode as a positive electrode of the second hybrid capacitor and the fourth electrode as a negative electrode as the negative electrode of the second hybrid capacitor; and
forming an electric double-layer capacitor in the energy storage device and that comprises the first electrode as a positive electrode of the electric double-layer capacitor and the fourth electrode as a negative electrode of the electric double-layer capacitor.

21. The method of claim 20, further comprising disposing an insulator between any two adjacent electrodes.

22. The method of claim 20, further comprising introducing an electrolyte amongst the first positive electrode, the first negative electrode, the second positive electrode and the second negative electrode.

23. A method to make an energy storage device, comprising:
aligning a plurality of electrodes so that a first electrode, a second electrode, a third electrode and a fourth electrode are aligned substantially in parallel with each other;
forming a first battery in the energy storage device and that comprises the first electrode as a positive electrode of the first battery and the second electrode as a negative electrode of the first battery;
forming a hybrid capacitor in the energy storage device and that comprises the third electrode as a positive electrode of the hybrid capacitor and the second electrode as a negative electrode of the hybrid capacitor;
forming a second battery in the energy storage device and that comprises the third electrode as a positive electrode of the second battery and the fourth electrode as a negative electrode of the second battery; and
forming an electric double-layer capacitor in the energy storage device and that comprises the first electrode as a positive electrode of the electric double-layer capacitor and the fourth electrode as a negative electrode of the electric double-layer capacitor.

24. The method of claim 23, further comprising disposing an insulator between any two adjacent electrodes.
